(19) United States
(12) Patent Application Publication
(10) Pub. No.: US 2023/0051229 A1
(43) Pub. Date: Feb. 16, 2023

(54) TRANSMISSION DEVICE FOR TRANSMITTING DATA

(71) Applicant: SIEMENS MOBILITY GMBH, München (DE)

(72) Inventors: Rainer FALK, Poing (DE); Christina OTTO, Muenchen (DE); Heiko PATZLAFF, München (DE); Martin WIMMER, Neubiberg (DE)

(21) Appl. No.: 17/783,342

(22) PCT Filed: Dec. 10, 2020
(86) PCT No.: PCT/EP2020/085508

§ 371 Date: Jun. 8, 2022

(30) Foreign Application Priority Data
Dec. 19, 2019 (DE) 10 2019 220 246.2

(51) Int. Cl. H04L 9/40

(52) U.S. Cl. CPC H04L 63/0209; H04L 63/1441

(57) ABSTRACT

A transmitting data between a real first network and a real second network is provided. The transmission device has a first network port for coupling to the real first network and a second network port for coupling to the real second network and also comprises: a simulation unit which is connected to the first network port and which is configured to receive network-specific data from the real first network via the first network port, to provide, in accordance with the received network-specific data, a virtual simulation network of the real first network, and to prepare the provided virtual simulation network, via the second network port, for access to the provided virtual simulation network by the real second network. The transmission device provided allows an attacker to be deliberately deceived, which increases security against attempts to access the real first network from the real second network.

### CROSS-REFERENCE TO RELATED APPLICATIONS

This application claims priority to PCT Application No. PCT/EP2020/085508, having a filing date of Dec. 10, 2020, which claims priority to DE Application No. 10 2019 220 246.2, having a filing date of Dec. 19, 2019, the entire contents both of which are hereby incorporated by reference.

### FIELD OF TECHNOLOGY

The following relates to a transmission device for transmitting data between a real first network and a real second network.

### BACKGROUND

For secure communication between a security-critical network, such as a production network or a railway safety network, and an open network such as a local area network or the internet, transmission devices such as data diodes or firewalls are conventionally used, in particular to provide one-way data transmission between the security-critical network and the open network. For example, these transmission devices are designed to ensure that no data of any kind can be transmitted from the open network to the security-critical network, and are additionally designed in particular to protect the security-critical network from attacks and intrusion attempts.

### SUMMARY

An aspect relates to an improved transmission device.

According to a first aspect, a transmission device for transmitting data between a real first network and a real second network is proposed. The transmission device has a first network port for coupling to the real first network and a second network port for coupling to the real second network and also comprises:
a simulation unit, which is connected to the first network port and configured to receive network-specific data from the real first network via the first network port, to provide a virtual simulation network of the real first network in accordance with the network-specific data received, and to prepare the provided virtual simulation network, via the second network port, for access to the provided virtual simulation network from the real second network.

The transmission device provided makes it possible to provide a virtual simulation network of the real first network via the second network port by real network-specific data, for example of real nodes of the real first network. As a result, if an attacker attempts to access or attack the supposedly first real network, namely the virtual simulation network, from the real second network, the attacker will in reality attack or access the virtual simulation network instead of the real first network.

The advantage of this deliberate deception of the attacker is to increase the security against accesses or attacks on the real first network from the real second network, thus increasing the reliability and security of data transmission between the real first network and the real second network.

The term “real” in the present case is understood in particular to mean that the first network and the second network are implemented in reality as an existing network. The existing network can be a physical network, for example implemented in hardware, or a virtual (virtualized) network, for example implemented by virtual machines and/or virtual switches, or a hybrid network (partially virtualized network). A virtualized network, such as a virtual first network, is a network that is set up virtually or implemented as a network virtualization, for example.

The term “virtual” in the present case may be understood to mean that the simulation network simulates or virtually models the first real network. In particular, the virtual simulation network simulates at least parts or nodes of the real first network. In particular, their function and effect are simulated by the virtual simulation network. A simulated node can also be described as a so-called “honeypot” and the simulation of a real network can be described as a simulation of a “honeypot network”, also known as a honeynet. The simulation unit can also be configured to create a plurality V of virtual simulation networks of a plurality N of real first networks and to provide this plurality V via the second network port.

The terms “connect” and “connected” are understood in the present case to mean in particular that a unit, for example the simulation unit, is directly or indirectly connected via at least one other component or unit to, for example, the first network port or other components of the transmission device.

A network port, such as the first or second network port, is implemented in particular as a physical network port. In embodiments, the physical network port may have an RJ-45 connection, an M12 connection, or a single-pair Ethernet connection in order to be connected or coupled to the real first network or the real second network respectively. For example, the transmission device may comprise additional network ports in addition to the first and second network ports. Also, the first and/or the second network port can be part of a network address that allows the assignment of TCP connections (Transmission Control Protocol) and UDP connections (User Datagram Protocol) and data packets to servers and/or clients arranged in the real first and/or real second network.

In particular, the simulation unit is configured to simulate the real first network when providing the virtual simulation network. In other words, in embodiments the provision by the simulation unit may comprise a simulation of the real first network.

In particular, the access is an access by a node or an attack on the virtual simulation network by an attacker from the real second network via the second network port. The attack can be a software attack, in particular a hacker attack. In particular, a software attack is an attack on the virtual simulation network from the real second network via the second network port. The attack may also include an attempted attack and/or an intrusion attempt on the transmission device.

According to one embodiment, the simulation unit is also configured to simulate the virtual simulation network in accordance with at least three different simulation levels.

According to a further embodiment, the simulation unit is configured, depending on the network-specific data received, to simulate the virtual simulation network in a first simulation level of the at least three different simulation levels by at least one network topology of the real first network, in a second simulation level of the at least three different simulation levels by at least one layer of a network protocol and/or a display of a service based on the real first network, and in a third simulation level of the at least three different simulation levels by at least one content-plausible website based on the real first network.

By simulating the virtual simulation network by different simulation levels, it is possible to make only certain data of the real first network, which depends on the respective simulation level, available to the attacker from the real second network or to have it displayed to the attacker by the virtual simulation network. By each increase in the simulation level, for example if the virtual simulation network is increased from the first to the second simulation level, additional data of the real first network can be made available to the attacker through the virtual simulation network. As a result, each time the simulation level is increased the virtual simulation network is modeled increasingly accurately in relation to the real first network. In other words, each time the simulation level is increased, the virtual simulation network comprises additional data from the real first network.

This increases the likelihood that the attacker will try to access or attack the virtual simulation network and thus increases the likelihood of the attacker being deceived. The advantage of this is to increase the security against accesses or attacks on the real first network from the real second network, thus increasing the reliability and security of data transmission between the real first network and the real second network.

A network topology of the real first network comprises in particular one or more endpoints of the real first network. An endpoint is in particular an interface of a node of the real first network. For example, a node is a computer, such as a server, client, or router. The network topology comprises in particular the arrangement of the nodes and the connection of the nodes among one another in the real first network. The same applies to the real second network.

One layer of a network protocol is in particular part of the TCP/IP reference model (“Transmission Control Protocol”/“Internet Protocol”), which represents a group of network protocols using different layers.

The first simulation level comprises in particular the simulation of the network topology, the network ports existing in the network topology, and furthermore, which network ports are reachable and which are unreachable. The first simulation level can be assigned in particular to layers 1-3 according to the OSI/ISO layer model, so that the physical nodes of the real first network together with their media-access-control (MAC) address and/or internet protocol address (IP address) can be simulated in the virtual simulation network in the first simulation level.

The use of the first simulation level alone has the particular advantage that the simulation of the virtual simulation network requires a small amount of memory and computing capacity, as the resulting simulation effort is low due to the simulated network topology with the network ports.

The second simulation level comprises, in particular, the simulation of a layer of a network protocol or a display of a service. For example, a service is the simulation of a TCP/UDP port (“User Datagram Protocol”) or a generated response to an HTTP request (“Hypertext Transfer Protocol”) by a randomly generated blank web page.

In embodiments, the third simulation level may comprise the simulation of a web page with plausible content. A content-plausible web page can correspond to a web page that displays the graphical user interface, for example, of a programmable logic controller (PLC) software. This graphical user interface of the content-plausible web page can then display measured values, such as pressure or temperature, of a real PLC that controls a real machine of the real first network. The measured values can also be simulated in such a way that they change arbitrarily over time. Also, these measured values can be modified in response to an attack by the attacker in such a way that the attacker will assume that they have successfully attacked the real system or the PLC of the real first network. Likewise, the content-plausible web page can be designed as a static web page, which does not change its graphical interface. The third simulation level also comprises the simulation of an application logic of the first network. In embodiments, the application logic may comprise algorithms and/or rules for describing functions of endpoints, such as nodes, of the first network.

These simulation means using the third simulation level lead the attacker to assume that they are browsing the real, actual web page of the real first network or accessing the real first network. This significantly increases the likelihood of deceiving the attacker. The advantage of this is to increase the security against accesses or attacks on the real first network from the real second network, thus increasing the reliability and security of data transmission between the real first network and the real second network.

In addition, it is conceivable that technical processes of real machines of the real first network can be simulated in the third simulation level or in a further, numerically higher simulation level. In particular in a numerically very high simulation level, the virtual simulation network simulates exactly the real first network and its technical processes. As a result, the virtual simulation network or the honeypot is particularly realistic. This particularly realistic implementation can also be described as a “digital twin”.

The different simulation levels correspond in particular to the layers of the OSI/ISO layer model.

According to another embodiment, the transmission device further comprises a configuration unit, which is configured to receive network-specific data from the real first network via the first network port, to analyze the data and to use the analyzed network-specific data as configuration data for configuring the virtual simulation network.

According to another embodiment, the configuration unit is further designed to configure the virtual simulation network automatically using the configuration data at least at a specific point in time, the at least one specific point in time comprising a point in time during the operation of the simulation unit.

The transmission device comprises in particular a CPU (“Central Processing Unit”) in which the simulation unit and the configuration unit are implemented. Each particular unit, for example, the simulation unit or the configuration unit, can be implemented in hardware and/or software technologies. In the case of a hardware-based implementation, the respective unit can be implemented as a device or as part of a device, for example as a computer or as a microprocessor or as a control computer of a vehicle. In the case of a software-based implementation, the respective unit can be implemented as a computer program product (non-transitory computer readable storage medium having instructions, which when executed by a processor, perform actions), as a function, as a routine, as part of a program code or as an executable object.

The configuration data comprises in particular the network-specific data of the real first network. The configuration data comprises at least the network topology of the real first network, the IP addresses of the nodes of the real first network, and the services that are executed on the real first network.

The configuration unit makes it possible to configure the virtual simulation network using the configuration data. The term “configure” is understood in particular to mean that the configuration unit sends to the simulation unit, in particular to the simulated virtual simulation network, data from the real first network that the configuration unit has already pre-processed, for example network topologies with the nodes, network ports or IP addresses of nodes. This eliminates the need for the simulation unit to extract or prepare the received network-specific data. This reduces the configuration effort required when configuring the virtual simulation network for the first time or when reconfiguring it.

In particular, the configuration unit can learn the network topology or the layout of the real first network by a machine learning algorithm, for example by neural networks. This also reduces the effort involved in the initial or repeated setup or configuration of the virtual simulation network.

The specific point in time comprises, in particular, a time during the operation of the simulation unit, during starting of the simulation unit, during a change in the simulation level, and/or a specific time defined by an operator or administrator of the transmission device.

According to another embodiment, the transmission device is configured to run the simulation unit and the configuration unit in parallel.

This embodiment has the advantage that the simulation unit and the configuration unit are executed simultaneously or in parallel, or are active or in operation at the same time. The parallel design of the configuration unit in combination with the simulation unit leads to the technical effect that, on the one hand, the virtual simulation network can be adapted in the respective simulation levels during operation by the simulation unit, and on the other hand, the initial and/or repeated configuration step is facilitated by a better database based on the configuration data of the configuration unit, thus reducing the configuration effort. In addition, the level of detail of the virtual simulation network can be increased. The most realistic simulation possible of the real first network increases the probability that potential attackers will be diverted from accessing the real first network, so that the security can be increased. As a result, the reliability and security of the data transmission between the real first network and the real second network are increased.

Parallel is understood to mean in particular that the transmission device is configured to run or operate the simulation unit and the configuration unit at the same time or simultaneously.

According to another embodiment, the transmission device is configured to receive data from the real first network via a network switch arranged between the real first network and the first network port, wherein at least one input of the network switch is connected to the real first network for data transmission and a mirror port implemented as an output of the network switch is connected to the first network port for data transmission.

Using a network switch with a mirror port makes it possible to provide the entire data traffic of the real first network at the first network port for the transmission device. This enables the transmission device to receive and analyze the data traffic of each node of the real first network.

In particular, a first connecting section is arranged between the real first network and the network switch, a second connecting section between the network switch and the transmission device, and a third connecting section between the transmission device and the real second network. In particular, the first connecting section establishes a connection between the real first network and the network switch. In embodiments, the second connecting section may establish a connection between the network switch and the transmission device. The third connecting section, for example, establishes a connection between the real second network and the transmission device. In particular, the first, second and/or third connecting section is wired, for example in the form of at least one copper cable or an aluminum cable, and/or implemented optically in the form of at least one fiber-optic cable. The network switch can also be referred to as a switch.

The mirror port of the network switch is used in particular to mirror the network traffic of the real first network in order to provide the entire data and/or network traffic of the real first network to the transmission device on the first network port.

According to another embodiment, the transmission device is configured to carry out data transmission between the real first network and the real second network in a transmission layer, layer 2 according to the OSI/ISO Layer model.

According to another embodiment, the real first network comprises a control network, in particular a production network or a railway safety network, and the real second network comprises a diagnostic network, a local network or the interne.

The real first network is designed in particular as a security-critical network, while the real second network is designed as an open network. Also, the real first network can be described as a network with a high security requirement, while the real second network can be described as a network with a low security requirement.

A production network is used in particular in a production plant. In particular, the production plant comprises a plurality of machines and computers connected to one another via the production network.

A railway safety network may comprise control and safety technology for a rail infrastructure.

The control network comprises in particular a road safety network which has control and safety technology for a road infrastructure.

For example, a local network comprises a local area network (LAN) and/or a wireless local area network (WLAN).

The real first network and the real second network each comprise in particular at least one end point, which is implemented as a respective node. In particular, the real first network and/or the real second network each comprise a plurality of nodes that are connected to one another so as to form the respective network.

According to another embodiment, the transmission device is partially or completely designed as a unidirectional data diode, as a firewall, or as a gateway.

A unidirectional data diode is, in particular, a one-way communication device that enables a physically interaction-free separation of the real first network from the real second network. In particular, the unidirectional data diode is designed as a “Data Capture Unit” (DCU). A “physically” interaction-free separation is present in particular if the non-interactive separation physically separates the real first and the real second network due to physical components in the unidirectional data diode.

A firewall is in particular a component that is implemented in hardware and/or software, in particular software, and that is configured to establish a connection between a real first and a real second network. The firewall can also be designed as a unidirectional firewall, which enables a logical, interaction-free separation of the real first network and the real second network. The term “logical” interaction-free separation is understood in the present case to mean in particular that the interaction-free separation is effected by an application of algorithms, in the case where the firewall is implemented in software.

A gateway is in particular a component that is implemented in hardware and/or software and that is configured to establish a connection between a real first and a real second network. The gateway can also be designed as a unidirectional gateway, which enables a physically or logically interaction-free separation of the real first network and the real second network.

Furthermore, the unidirectional data diode, the unidirectional firewall and the unidirectional gateway are in particular each configured to allow only approved and/or specially marked data for transmission from the real second network into the real first network.

In particular, the term “interaction-free separation” is understood to mean that changes or attempted attacks from the real second network have no influence on the real first network.

In this case the term “partial” is understood to mean in particular that the transmission device also comprises other components in addition to the unidirectional data diode, the firewall or the gateway. For example, the unidirectional data diode is part of the transmission device, with the transmission device also having other components.

In particular, the term “complete” is understood to mean here that the transmission device as a whole is implemented as a unidirectional data diode, as a firewall or as a gateway.

According to another embodiment, the transmission device is configured to provide the real second network with a routing table comprising a plurality A of IP addresses of nodes of the real first network.

In particular, the routing table is a table that shows which nodes of a network, such as the real first network, can be reached via which IP addresses or which IP addresses are assigned to the nodes. This means that another network, such as the real second network, has information about the IP address via which a node of the real first network can be reached from the real second network.

According to another embodiment, the transmission device is configured to provide the real second network with at least one specific IP address of a specific node of the real first network.

The provided routing table provides at least one specific IP address of a specific node from the real first network to the real second network.

In particular, this specific IP address provided may be used as a trap that has a technical endpoint. For example, if an attacker tries to attack the specific node via the transmission device using the specific IP address assigned to that node, the attack will end at the technical endpoint. The technical endpoint is designed in particular to be isolated from the real first and real second networks. Thus, a deliberate deception of the attacker is effected by the specified IP address and the routing table in order to increase the security and reliability during the operation of the transmission device and the real first network.

According to another embodiment, the network-specific data comprises measured values, such as pressure and/or temperature of nodes of the real first network, at least a number T of nodes of the real first network, operating states of nodes of the real first network, and/or a technical process executed by at least one node of the real first network.

According to another embodiment, at least the simulation unit, the configuration unit, the first network port and the second network port are implemented in a common housing.

Thus, the components listed in this embodiment, including the transmission device itself, are implemented in particular in a common housing.

In particular, a housing or a common housing is designed as a package of a processor or computer chip, for example in the form of an integrated circuit (IC). Furthermore, in embodiments, a housing or a common housing may be designed as a common housing of a device or, for example, as a common implementation on an FPGA (field programmable gate array).

Further possible implementations of embodiments of the invention also comprise combinations of features either described previously or in the following in relation to the exemplary embodiments, which are not explicitly mentioned. A person skilled in the art will also be able to add individual aspects as improvements or additions to each basic form of embodiments of the present invention.

### BRIEF DESCRIPTION

Some of the embodiments will be described in detail, with reference to the following figures, wherein like designations denote like members, wherein:

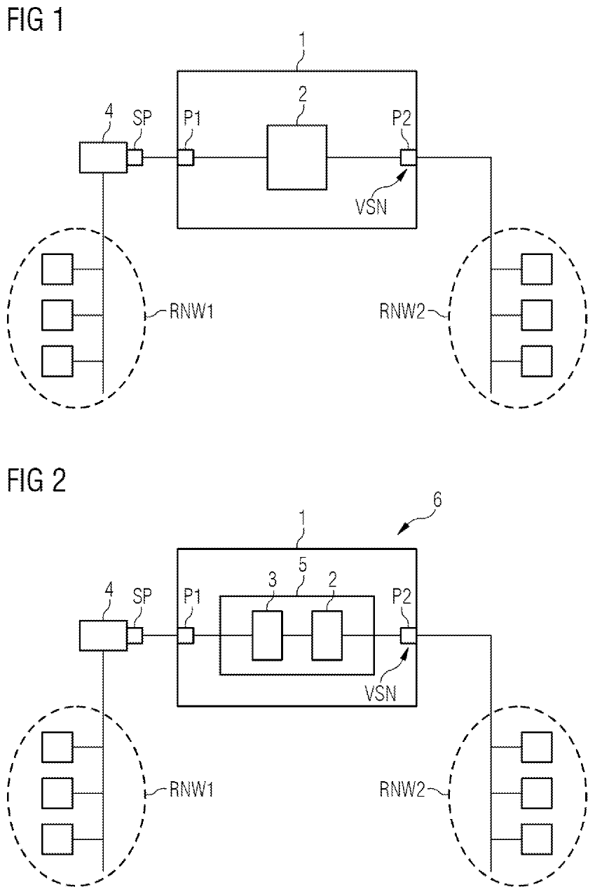

FIG. 1 shows a schematic block diagram of a first embodiment of a transmission device for transmitting data; and

FIG. 2 shows a schematic block diagram of a second embodiment of a transmission device for transmitting data.

### DETAILED DESCRIPTION

FIG. 1 shows a schematic block diagram of a first embodiment of a transmission device 1 for transmitting data between a real first network RNW1 comprising a production network, for example, and a real second network RNW2 comprising a local network, for example. This transmission of data is carried out in particular in a transmission layer, layer 2 according to the OSI/ISO Layer model. In another embodiment, the real first network RNW1 can comprise a railway safety network, while the real second network RNW2 comprises the internet.

In FIG. 1, the transmission device 1 is formed completely as a unidirectional data diode. In another embodiment, the transmission device 1 may be partially or completely designed as a firewall (not shown) or as a gateway (not shown).

The transmission device 1 has a first network port P1 for coupling to the real first network RNW1 and a second network port P2 for coupling to the real second network RNW2. In addition, the transmission device 1 comprises a simulation unit 2.

The simulation unit 2 is connected to the first network port P1, which is configured to receive network-specific data from the real first network RNW1 via the first network port P1, to provide a virtual simulation network VSN of the real first network RNW1 in accordance with the network-specific data received, and to prepare the provided virtual simulation network VSN, via the second network port P2, for access to the provided virtual simulation network VSN from the real second network RNW2.

The network-specific data comprises in particular measured values, such as pressure and/or temperature of nodes of the real first network RNW1, or at least a number of T of nodes of the real first network RNW1. In embodiments, the network-specific data may also comprise operating states of nodes of the real first network RNW1, or a technical process that is executed by at least one node of the real first network RNW1.

In particular, the simulation unit 2 is configured to simulate the virtual simulation network VSN in accordance with at least three different simulation levels.

The simulation unit 2 is configured, in accordance with the network-specific data received, to simulate the virtual simulation network VSN in a first simulation level by at least one network topology of the real first network RNW1, and in a second simulation level by at least one layer of a network protocol and/or a display of a service on the basis of the real first network RNW1. The simulation unit 2 is also configured, in accordance with the received network-specific data, to simulate the virtual simulation network VSN in a third simulation level by at least one content-plausible web page based on the real first network RNW1.

FIG. 1 also shows a network switch 4 arranged between the real first network RNW1 and the first network port P1.

The transmission device 1 in this case is configured to receive the data from the real first network RNW1 via the network switch 4. At least one input of the network switch 4 is connected to the real first network RNW1 for data transmission. A mirror port SP designed as an output of the network switch 4 is connected to the first network port P1 for transmitting data.

In embodiments, the transmission device 1 may be configured to provide the real second network RNW2 with a routing table comprising a plurality A of IP addresses of nodes of the real first network RNW1. The transmission device 1 is also configured to provide the second RNW2 network with at least one specific IP address of a specific node from the real first network RNW1.

FIG. 2 shows a schematic block diagram of a second embodiment of a transmission device 1 for transmitting data. The second embodiment comprises all the features of the first embodiment. In addition, the transmission device 1 of the second embodiment in FIG. 2 comprises a configuration unit 3, which is connected to the simulation unit 2, and a CPU 5 in which the simulation unit 2 and the configuration unit 3 are implemented.

The configuration unit 3 is configured to receive network-specific data from the real first network RNW1 via the first network port P1, to analyze this data and to use the analyzed network-specific data as configuration data for configuring the virtual simulation network VSN.

In the second embodiment, the transmission device 1 comprising at least the simulation unit 2, the configuration unit 3, the first network port P1 and the second network port P2 are also implemented in a common housing 6.

The configuration unit 3 is further designed to configure the virtual simulation network VSN automatically at least at a specific point in time using the configuration data. The specific point in time includes in particular a point in time during the operation of the simulation unit 2.

In an embodiment, the transmission device 1 is configured to run the simulation unit 2 and the configuration unit 3 in parallel.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

### LIST OF REFERENCE SIGNS

1 transmission device
2 simulation unit
3 configuration unit
4 network switch
5 CPU
6 housing
P1 first network port
P2 second network port
RNW1 real first network
RNW2 real second network
SP mirror port
VSN virtual simulation network

1. A transmission device for transmitting data between a real first network and a real second network, wherein the transmission device has a first network port for coupling to the real first network and a second network port for coupling to the real second network and also comprises:
a simulation unit, connected to the first network port, which is configured to receive network-specific data from the real first network via the first network port, to provide a virtual simulation network of the real first network in accordance with the network-specific data received, and to prepare the provided virtual simulation network, via the second network port, for access to the provided virtual simulation network from the real second network.

2. The transmission device as claimed in claim 1, wherein the simulation unit is also configured to simulate the virtual simulation network in accordance with at least three different simulation levels.

3. The transmission device as claimed in claim 2, wherein the simulation unit is configured, depending on the network-specific data received, to simulate the virtual simulation network in a first simulation level of the at least three different simulation levels by at least one network topology of the real first network, in a second simulation level of the at least three different simulation levels by at least one layer of a network protocol and/or a display of a service based on the real first network, and in a third simulation level of the at least three different simulation levels by at least one content-plausible web page based on the real first network.

4. The transmission device as claimed in claim 1, wherein the transmission device further comprises a configuration unit, which is configured to receive network-specific data from the real first network via the first network port, to analyze the data and to use the analyzed network-specific data as configuration data for configuring the virtual simulation network.

5. The transmission device as claimed in claim 4, wherein the configuration unit is further configured to configure the virtual simulation network automatically using the configuration data at least at a specific point in time, the at least one specific point in time comprising a point in time during the operation of the simulation unit.

6. The transmission device as claimed in claim 4, wherein the transmission device is configured to run the simulation unit and the configuration unit in parallel.

7. The transmission device as claimed in claim 1, wherein the transmission device configured to receive the data from the real first network via a network switch arranged between the real first network and the first network port, wherein at least one input of the network switch is connected to the real first network for data transmission and a mirror port implemented as an output of the network switch is connected to the first network port for data transmission.

8. The transmission device as claimed in claim 1, wherein the transmission device is configured to carry out data transmission between the real first network and the real second network in a transmission layer, layer 2 according to the OSI/ISO Layer model.

9. The transmission device as claimed in claim 1, wherein the real first network comprises a control network, and the real second network comprises a diagnostic network, a local network, or the internet.

10. The transmission device as claimed in claim 1, wherein the transmission device is partially or completely configured as a unidirectional data diode, as a firewall, or as a gateway.

11. The transmission device as claimed in claim 1, wherein the transmission device is configured to provide the real second network with a routing table comprising a plurality A of IP addresses of nodes of the real first network.

12. The transmission device as claimed in claim 1, wherein the transmission device is configured to provide the real second network with at least one specific IP address of a specific node of the real first network.

13. The transmission device as claimed in claim 11, wherein the network-specific data comprises measured values, at least a number T of nodes of the real first network, operating states of nodes of the real first network and/or a technical process executed by at least one node of the real first network.

14. The transmission device as claimed in claim 4, wherein at least the simulation unit, the configuration unit the first network port and the second network port are implemented in a common housing.
